(19) United States
(12) Patent Application Publication
(10) Pub. No.: US 2017/0152692 A9
(43) Pub. Date: Jun. 1, 2017

(54) ADJUSTABLE SLIDING DOOR SYSTEM

(71) Applicant: DecoSlide Company ApS, Silkeborg (DK)

(72) Inventor: Anders Hornebo, Silkeborg (DK)

(73) Assignee: DecoSlide Company ApS, Silkeborg (DK)

(21) Appl. No.: 14/415,816

(22) PCT Filed: Jul. 5, 2013
(86) PCT No.: PCT/DK2013/050226

§ 371 Date: Jan. 20, 2015

(30) Foreign Application Priority Data
Jul. 20, 2012 (DK) PA 2012 70447

(51) Int. Cl. E05D 15/10; E05D 15/06; E06B 3/46

(52) U.S. Cl. CPC E05D 15/10; E06B 3/469; E05D 15/06; E05D 15/0604

(57) ABSTRACT

An adjustable sliding door system for building a sliding door for use in delimiting a part of a room in an opening and extending from the floor to the ceiling of the room is adapted to run in a track positioned opposite it on, respectively, the ceiling and the floor of the room. The adjustable sliding door system has two profiles constituting the sides of said sliding door and surface elements mounted between the profiles and constituting the surface of the sliding door. The adjustable sliding door system has a plurality of surface elements adapted to be mounted overlapping and in continuation of each other in a length corresponding to the height of the opening. This embodiment has the advantage that, based on few standard elements, a very flexible solution is obtained for building a sliding door of any height and where colors/decors may be varied according to personal desires.

### BACKGROUND OF THE INVENTION

1. Field of the Invention

The present invention relates to an adjustable sliding door system for building a sliding door adapted to be used for delimiting a part of a room in an opening and extending from the floor to the ceiling of said room, said sliding door is adapted to run in a track positioned opposite on respectively the ceiling and the floor of the room, wherein said adjustable sliding door system comprises two profiles constituting the sides of said sliding door.

2. Description of Related Art

Current sliding doors systems are mostly available in connection with the purchase of closets. Usually, the buyer has a range of choices that fall within predefined dimensions.

Sliding doors are adapted to be used for delimiting a part of a room in an opening and could extend from the floor to the ceiling of a room and could be mounted in front of any opening such as a door opening or be mounted as an intermediate wall.

In connection with sliding doors to be used for delimiting a part of a room and extending from the floor to the ceiling, standard height sliding doors cannot be used since distances between floor and ceiling in rooms may vary significantly. Today sliding doors for this purpose are produced in customized dimensions, but this implies increased costs for the customer. Furthermore, customized solutions are quite cumbersome to handle for both producers as well as distributors seeing that more time is required for manufacturing of the customized sliding doors and their components. Furthermore, the required customization results in long delivery time from placing of the order to receipt of the goods.

Alternatively, standard sliding doors may be produced, but this requires that customized fillets are added for covering any gap between the sliding door and the floor or ceiling.

Hence, there is a need in the technical field of sliding door systems overcoming the above-mentioned drawbacks.

### SUMMARY OF THE INVENTION

The object of the invention is to solve the above-mentioned problems.

The object of the invention is obtained by an adjustable sliding door system as described initially above, wherein the adjustable sliding door system comprises a plurality of surface elements adapted to be mounted overlapping and in continuation of each other in a length corresponding to the height of the opening.

Hence, the advantage of the invention is that the customer may build a sliding door (or a plurality of interconnected sliding doors), which is tailored to any opening (e.g., for closets, entrances and the like) without being bound to predefined sizes. Based on few standard elements a very flexible solution is obtained where a sliding door of any height may be built and colors/decors may vary in relation to personal desires.

This embodiment has the advantage that a very flexible solution is obtained where a sliding door of any height may be built and furthermore colors/decors may vary in relation to personal desires. Thereby the sliding door manufacturer only needs to produce standard components for the sliding door system, and the user can then easily from these standard components assemble a sliding door having a specific height corresponding to the opening where the sliding door is to be mounted. Furthermore, by having a system where the sliding doors are being assembled at the point of use, transportation of the sliding doors is much simpler and less space consuming. Sliding door systems can be transported using standard cars.

For each sliding door to be mounted in an opening, the sliding door system comprises two profiles and surface elements. The process of adding a sliding door in an opening using the sliding door system according to the present invention is as follows:
1. Initially the height of the opening is measured (the distance between the floor and the ceiling).
2. The surface elements have a predefined width and are positioned in continuation of each other and overlapping until a length is obtained corresponding to the height of the opening. This could in one embodiment be done by using an indicator, e.g., measurement tape also included in the sliding door system.
3. Next, the two profiles are cut in a length corresponding to the height of the opening, and they are being connected to the surface elements. It is the mounting of profiles to the surface elements that stabilizes the sliding door.
4. Finally, rollers are mounted, e.g., on a bottom plate being mounted to the sliding door, and the sliding door is ready to be inserted in the opening for running along a track already mounted in the opening. The track could in one embodiment also be included in the sliding door system.

By the process as mentioned above, the height of the sliding door is adjustable, whereas the width of the sliding door is predefined.

The sliding doors build from a sliding door system according to the present invention have a maximum height corresponding to the length of the profiles in the system before cutting.

In an embodiment, the surface elements comprises a plurality of front surface elements adapted to be mounted between said profiles of said sliding door, and wherein the front surface elements are adapted to be mounted overlapping and in continuation of each other in a length corresponding to the height of the opening. In this way, standard sized front surface elements can be positioned overlapping and in continuation of each other covering any height, only the number of elements and the amount of overlapping needs to be adjusted.

In an embodiment of the invention, each front surface element comprises at least one recessed edge for engaging with a neighboring front surface element. This embodiment has the advantage that neighboring elements may be attached together in an effortless and quick manner.

In an embodiment of the invention the surface elements comprises front surface elements and back plates, wherein the front surface elements are positioned in a mutual distance introducing a gap between said front surface elements, and wherein the back plates are meant for positioning behind the front surface elements for covering said mutual distance between two neighboring front surface elements. This embodiment has the advantage that front surface elements may be interconnected by such back plates, and the back plates make the distance between front surface elements flexible since any gap may be covered by the back plate.

In an embodiment of the invention, each back plate comprises elongated grooves along the width of the back plate, wherein said elongated grooves are adapted for engaging with said front surface elements. This embodiment has the advantage that the distance between two front surface elements may be adjustable, and further it is assured that any back plates and front surface elements are being connected in a similar manner.

In an embodiment of the invention, the system further comprises rollers for rolling the lower part of said sliding door along said track, the rollers being adapted to be mounted at the upper and/or lower corners of said sliding door. This embodiment has the advantage that the sliding door more easily may slide into the track.

In an embodiment of the invention, at least one of the profiles comprises handlers for handling said sliding door. This embodiment has the advantage that the sliding door may be more comfortably handled.

In an embodiment, the system further comprises measuring tape adapted to be mounted behind the front surface elements for positioning the front surface elements for covering a length corresponding to the height of the opening.

In the following, embodiments of the invention will be described with reference to the accompanying drawings.

### BRIEF DESCRIPTION OF THE DRAWINGS

FIG. 1a illustrates a closet with a sliding door made from a sliding door system according to the present invention,

FIG. 1b illustrates a sliding door system according to the present invention being used for building a sliding door,

FIG. 1c illustrates surface elements comprising overlapping front surface elements,

FIG. 1d illustrates surface elements comprising overlapping back plates and front surface elements overlapping,

FIG. 2 illustrates an embodiment of the sliding door system according to the present invention comprising back plates,

FIG. 3 illustrates an embodiment of the sliding door system according to the present invention comprising front surface elements with a recessed edge,

FIG. 4 illustrates an embodiment of the sliding door system according to the present invention comprising several top plates,

FIG. 5 illustrates rollers mounted on the lower parts of the sliding door,

FIG. 6 illustrates a top guide mounted on the top part of the sliding door.

### DETAILED DESCRIPTION OF THE INVENTION

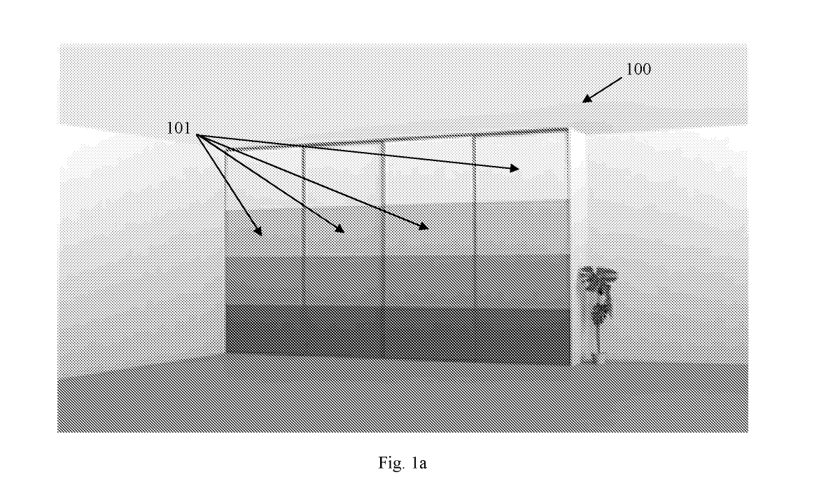

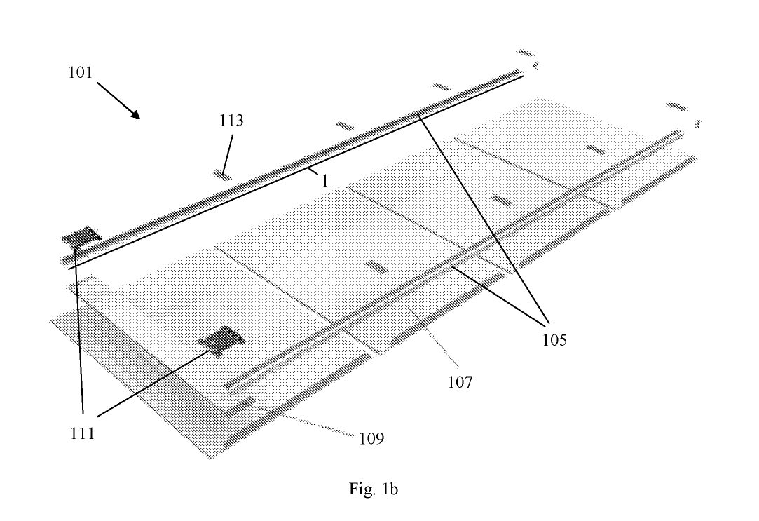

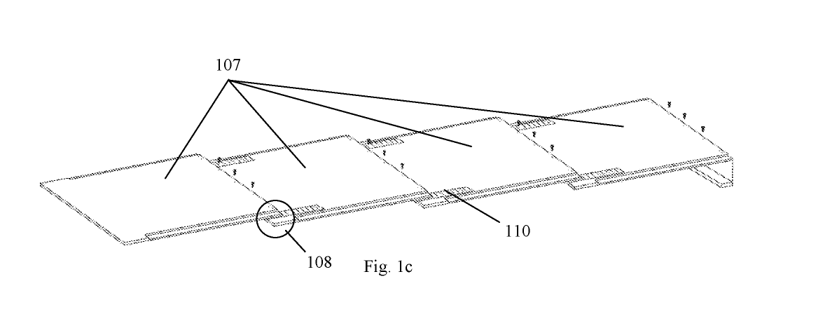

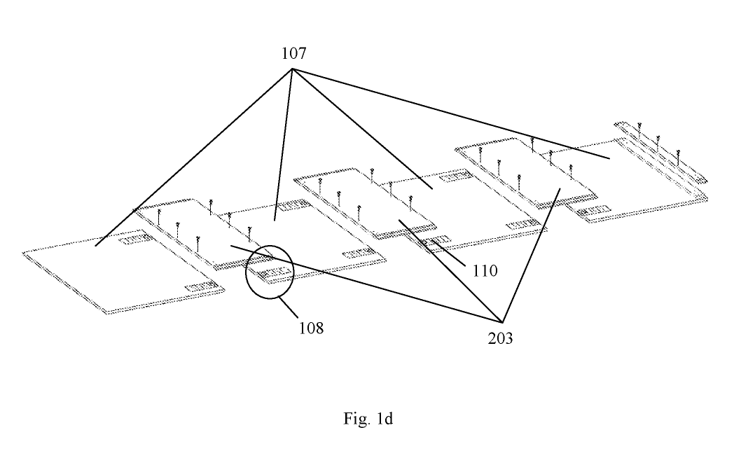

FIG. 1a illustrates a closet 100 where sliding doors 101 made from a sliding door system according to the present invention are mounted in front of an opening in the closet 100 in a sliding door track. This is an example of four sliding doors 101 being mounted in the opening between the floor and the ceiling of a room. By sliding any of these four doors 101 to either side of the closet 100, access to the interior of the closet 100 is enabled. Sliding doors 101 are mounted in front of a closet 100, but sliding doors 101 could be mounted in front of any opening such as a door opening or as an intermediate wall.

FIG. 1b illustrates a sliding door system according to the present invention being used for building a sliding door 101. The sliding door system comprises profiles 105 and surface elements comprising front surface elements 107. The sliding door system is transported to the customer as separate profiles 105 and surface elements, comprising front surface elements 107, and when the costumer receives these elements the sliding door 101 is build using these elements. This is done by connecting the profiles 105 to the surface elements.

The length of the profiles 105 constitutes the height of the sliding door 101, and the profiles 105 could be delivered having the exact required length l. Alternatively, the profiles 105 could be delivered having a standard length l, which is then cut by the costumer into the exact length l of interest according to the required height of the sliding door 101. In a specific embodiment, a marker could be added to the profile 105 to be delivered for easy identification of a cutting position.

The width of the surface elements constitutes the width of the sliding door 101. The profiles 105 and the surface elements could be connected using fasteners such as screws or nails or glue. In this example, profile brackets 113 are being used for connecting the profiles 105 to the front surface elements 107. Four front surface elements 107 are being used in this situation for covering the entire length l of the sliding door 101.

A bottom plate 109 is attached between the profiles 105 onto the back side of the front surface element 107 positioned at the bottom of the sliding door 101 and is used to attach two rollers 111.

FIG. 1c illustrates the front surface elements 107 being positioned overlapping and in continuation of each other in a length corresponding to the height of the opening and thereby corresponding to the length of the profiles. Both the amount of overlapping 108 between neighboring front surface elements as well as the number of front surface elements can be adjusted to make the front surface elements 107 cover a surface corresponding to the length of the profile.

In the illustrated embodiment, indicators 110 are added to the front surface elements 107, the indicators 110 are added to make it possible to ensure that a corresponding overlapping is made with all overlapping front surface elements 107. This could be to ensure a similar visual impression of neighboring sliding doors or to ensure that the exact same overlapping is made with all front surface elements 107 and in all sliding doors 101 in a closet 100. The indicator 110 could further indicate a height of the sliding door and thereby be used to ensure a specific height of the sliding door when the front surface elements 107 have been positioned overlapping each other.

FIG. 1d illustrates another embodiment where the surface elements comprise both front surface elements 107 and back plates 203 being positioned overlapping and in continuation of each other in a length corresponding to the height of the opening and thereby corresponding to the length of the profiles. Both the amount of overlapping 108 between neighboring front surface elements and back plates 203 as well as the number of front surface elements 107 and back plates 203 can be adjusted to make the surface elements (107, 203) cover a surface corresponding to the length of the profile.

In the illustrated embodiment, markers 110 are added to the front surface elements 107, the markers 110 are added to make it possible to ensure that a corresponding overlapping is made with all overlapping front surface elements 107. This could be to ensure a similar visual impression of neighboring sliding doors or to ensure that the exact same overlapping is made with all front surface elements 107 and in all sliding doors 101. The indicator could further indicate a height of the sliding door and thereby be used to ensure a specific height of the sliding door when the front surface elements 107 have been positioned overlapping each other.

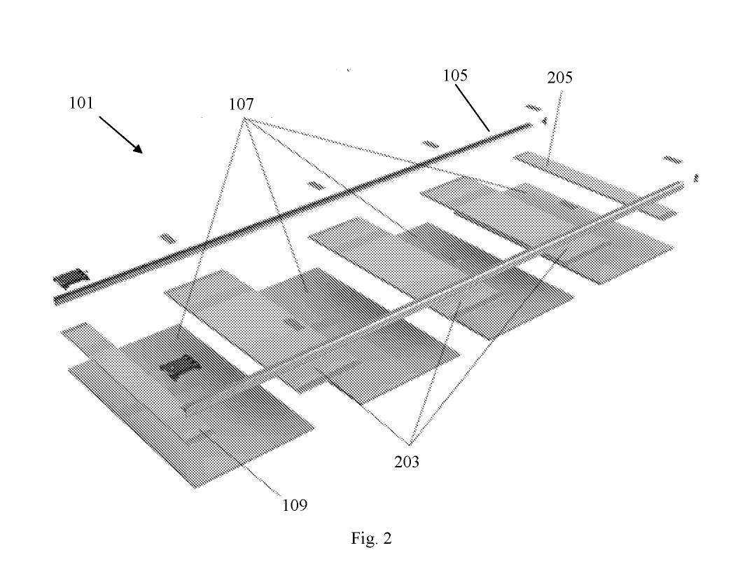

FIG. 2 illustrates an embodiment of the sliding door system according to the present invention comprising back plates 203, which are interposed between front surface elements 107 and are used to adjust the distance between the front surface elements 107. In this embodiment, a top plate 205 is attached between the profiles 105 onto the back side of the front surface element 107 positioned at the top of the sliding door 101 and a bottom plate 109 is attached in a similar manner positioned at the bottom of the sliding door 101.

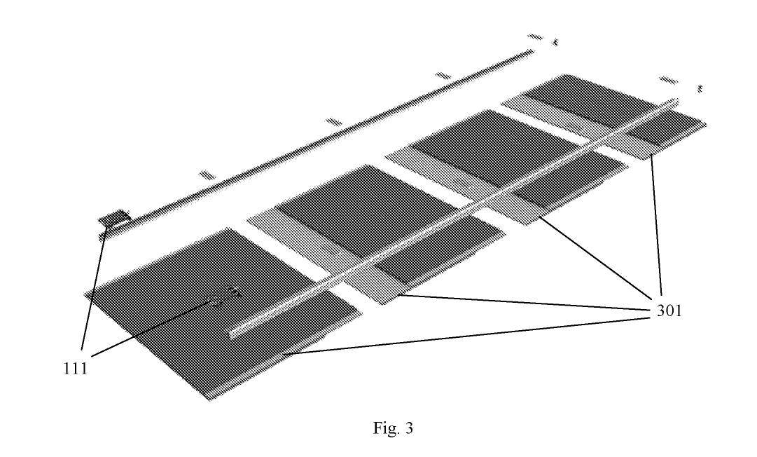

FIG. 3 illustrates an embodiment of the sliding door system according to the present invention comprising front surface elements with a recessed edge 301, which is used to interconnect neighboring front surface element. Note that, in this embodiment, the two rollers 111 are directly attached to the back side of the front surface element 107 positioned at the bottom of the sliding door 101.

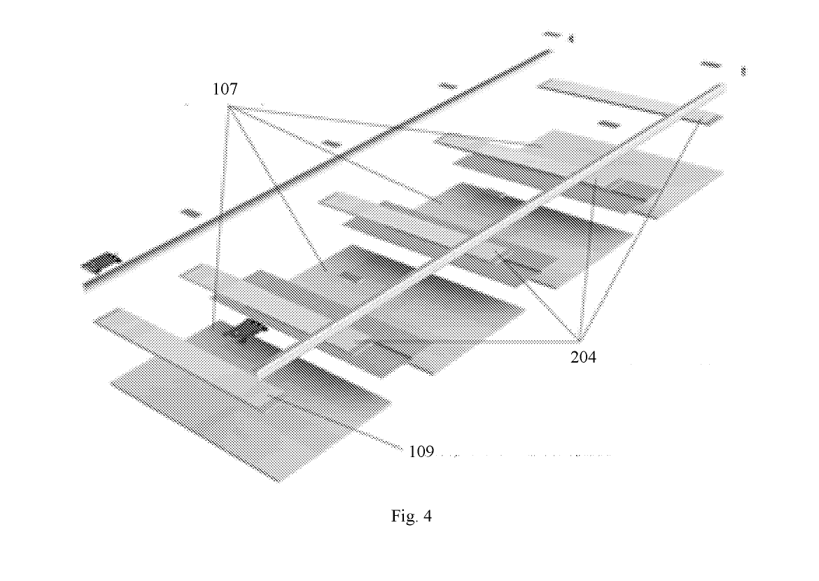

FIG. 4 illustrates an embodiment of the sliding door system according to the present invention comprising several mounting plates 204. The mounting plates 204 make it possible to connect back plates 203 and front surface plates 107 even though the back plates 203 are in a material not suitable for easy mounting to the front surface plates 107.

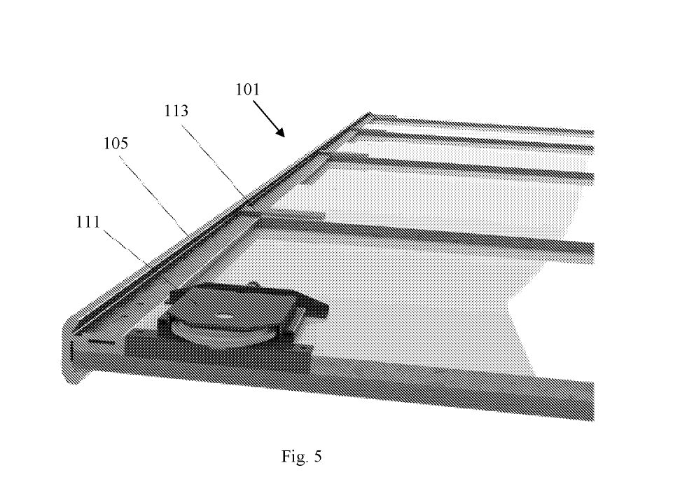

FIG. 5 illustrates rollers 111 mounted on the lower parts of the sliding door 101.

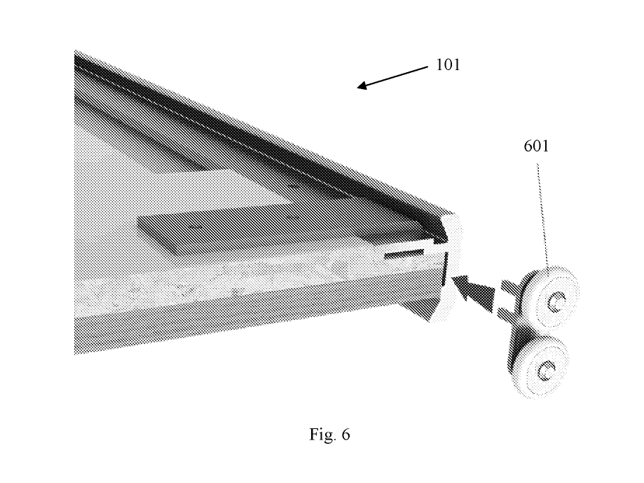

FIG. 6 illustrates a top guide 601 mounted on the top part of the sliding door 101.

Throughout this text it has been described that the sliding door system is meant for positioning in front of an opening. It is to be understood that an opening could be part of a room where the sliding door is meant for delimiting a part of a room and extending from the floor to the ceiling of the room. Further the opening could be an opening to a closet or an opening to another room.

What is claimed is:

1-8. (canceled)

9. A system for building a height-adjustable door, comprising a plurality of door leaf elements constituting a door leaf, each door leaf element having a front side and a back side, wherein said plurality of door leaf elements are adapted to be mounted overlapping each other such that the back side of at least one door leaf element at least partly overlaps with the front side of at least one neighboring door leaf element in continuation of each other so as to cover a distance corresponding to a desired height.

10. The system according to claim 9, wherein each door leaf element comprises at least one recessed edge for engaging with a neighboring door leaf element.

11. The system according to claim 9, wherein said door leaf elements comprise a plurality of front door leaf elements and at least one back door leaf element, said front door leaf elements being adapted to be positioned at a distance from each other and said back door leaf element being adapted to be positioned behind the front door leaf elements such that the front side of the back door leaf element at least partly overlaps with the back sides of the neighboring front door leaf elements for covering said distance.

12. The system according to claim 11, wherein each back door leaf element comprises elongated grooves along the width of the back door leaf element, said elongated grooves being adapted to engage with said front door leaf elements.

13. The system according to claim 9, wherein said system further comprises rollers for rolling said door along a track, said rollers being adapted to be mounted at at least one of upper and lower corners of said door.

14. The system according to claim 9, wherein said system further comprises two profiles constituting sides of said door, the door leaf elements being adapted to be mounted between said profiles.

15. The system according to claim 14, wherein at least one of said profiles comprises handles for handling said door.

16. The system according to claim 9, wherein said system further comprises indicators adapted to be mounted behind said front door leaf elements for positioning the front door leaf elements so as to cover the desired height.

17. A height-adjustable door, said door comprising a plurality of door leaf elements, each door leaf element having a front side and a back side, wherein said plurality of door leaf elements are mounted overlapping, such that the back side of at least one door leaf element at least partly overlaps with the front side of at least one neighboring door leaf element, and in continuation of each other, so as to cover a distance corresponding to a desired height.
